(19) United States
(12) Patent Application Publication
(10) Pub. No.: US 2021/0024048 A1
(43) Pub. Date: Jan. 28, 2021

(54) BRAKE DEVICE

(71) Applicant: Knorr-Bremse Systeme Fuer Nutzfahrzeuge GmbH, Muenchen (DE)

(72) Inventor: Huba NEMETH, Budapest (HU)

(21) Appl. No.: 16/981,252

(22) PCT Filed: Feb. 27, 2019
(86) PCT No.: PCT/EP2019/054820

§ 371 Date: Sep. 15, 2020

(30) Foreign Application Priority Data
Mar. 20, 2018 (DE) 10 2018 106 479.9

(51) Int. Cl. B60T 13/74; B60T 1/06

(52) U.S. Cl. CPC B60T 13/741; F16D 2066/005; B60T 1/062

(57) ABSTRACT

A brake device for a utility vehicle with a drivetrain, including: a vehicle brake, which is arranged along the drivetrain, as seen from at least one wheel hub, downstream of at least one transmission, in which the drivetrain includes the at least one electric drive motor, the at least one transmission and the at least one wheel hub. Also described is a related drive train, vehicle and utility vehicle.

### FIELD OF THE INVENTION

The present invention relates to a brake device, to a drivetrain, to a utility vehicle, and in particular to a high-speed brake for electrically operated utility vehicles.

### BACKGROUND INFORMATION

In conventional utility vehicles, the prime movers (for example internal combustion engines) are not installed on a drive axle. The driving power is transmitted by a cardan shaft from the prime mover to a differential, where branching to the individual wheel hubs or rims takes place.

In addition, conventional brakes are usually integrated in or at the wheel hub. For this purpose, wheel brakes typically have a rotor (a disk or a drum), which have the same speed of rotation as wheel to be braked.

For electrically operated vehicles, the prime mover can be integrated in the drive axle. This is a so-called E-axle. Frequently, the drives are additionally to be integrated as far as possible in or at the wheel hub.

FIG. 4A to 4C show examples of a conventional drivetrain 50, wherein a (drive) axle 101, 102 couples in each case to opposite wheel hubs 131, 132. On each of the axles 101, 102 there is formed a vehicle brake 141, 142 for braking the corresponding wheel hub 131, 132. On the wheel hubs there are to be mounted wheels, which are not necessarily included in the drivetrain - but may generally be present.

In the example of FIG. 4A, each axle 101, 102 is driven by a respective electric motor 111, 112, wherein a transmission 121, 122 is formed between the vehicle brakes 141, 142 and the respective electric motor 111, 112 in order to transform a torque and a rotational speed.

FIG. 4B shows a further conventional drivetrain 50, wherein an additional differential 150 is here formed along the vehicle axles 101, 102 between the two wheel hubs 131, 132 and couples to a further transmission 123. The further transmission 123 is located, for example, downstream of the differential 150 but still upstream of the electric drive motor 110. As in the example of FIG. 4A, there is formed in each case in FIG. 4B a vehicle brake 141, 142, which directly brakes the torque acting on the wheel hubs 131, 132.

FIG. 4C shows a further example of a conventional drivetrain 50, wherein a first wheel hub 131 has an integrated brake 141 and a transmission 121 is arranged between the first wheel hub 131 and the electric drive motor 111 which drives the first wheel hub 131. Both the electric drive motor 111 and the transmission 121 can be integrated at least partially in or at the first wheel hub 131.

The drivetrain 50 shown in FIG. 4C can then also be formed in the same manner (mirror-symmetrically) for the opposite, second wheel hub 132.

However, because the wheel brakes 141, 142 can have a considerable size (in order to absorb the acting torques), there is a space problem. It is frequently not possible to accommodate all the components—right up to the electric drive 110, 111, 112—on the E-axle close to the wheel hubs 131, 132.

There is therefore a need for suitable solutions for suitably integrating the vehicle brake in the so-called E-axles.

### SUMMARY OF THE INVENTION

At least part of the above-mentioned problems is solved by a brake device as described herein and a drivetrain as described herein. The further descriptions define further advantageous embodiments of the brake device and of the drivetrain.

The present invention relates to a brake device for a utility vehicle with a drivetrain, at least one electric drive motor, at least one transmission and at least one wheel hub. The brake device comprises at least one vehicle brake which is arranged along the drivetrain, as seen from the at least one wheel hub, downstream of the at least one transmission. The at least one vehicle brake is accordingly formed between the at least one transmission and the at least one electric drive.

Within the scope of the present invention, the transmission can comprise any transmission which is configured to convert a torque so that a higher torque acts on one side of the transmission than on the other side. Accordingly, on one side of the transmission there is a drive shaft of high speed and on the other side a drive shaft of lower speed. According to exemplary embodiments, the vehicle brake couples to the io drive shaft of high speed, where at the same time a lower torque acts than directly at the wheel hub. Because of the lower torque, the at least one vehicle brake can be of smaller dimensions, so that at least part of the above-mentioned problem is solved.

Within the scope of the present invention, a vehicle brake is to be understood as meaning also a brake which brakes only one wheel of the utility vehicle. The entire vehicle does not have to be braked by the at least one vehicle brake.

The vehicle brake is to be in particular a friction brake which effects the braking action via mechanical friction (e.g. using brake pads). However, the way in which the frictional force is applied can be as desired. Accordingly, the vehicle brake optionally comprises at least one of the following actuators: a pneumatic actuator, a hydraulic actuator, an electric actuator. These actuators effect a force action and thus generate the required friction.

Optionally, the vehicle brake is arranged along the drivetrain upstream or downstream of the electric drive motor.

Optionally, the vehicle brake comprises a parking brake function. The brake force can therefore also be caused by a spring (e.g. in a spring-loaded cylinder).

Optionally, the brake device comprises liquid cooling for the vehicle brake and/or the electric prime mover.

The present invention relates also to a drivetrain with an electric drive motor, a transmission and at least one wheel hub, wherein the transmission is arranged between the electric drive motor and the at least one wheel hub. The drivetrain additionally comprises one of the brake devices described above.

Optionally, a differential is present between the electric drive motor and the at least one wheel hub.

Optionally, two electric drive motors are present (the at least one electric drive is, for example, one such drive motor), which each couple to a wheel hub without a differential.

Optionally, the vehicle brake is arranged between the electric drive motor and the wheel hub.

Optionally, the transmission(s) is/are integrated in the wheel hub(s). Optionally, the vehicle brake(s) and/or the electric drive motor can also be integrated in the wheel hub(s).

Optionally, the at least one electric drive motor, the at least one transmission and the at least one vehicle brake are arranged along an axle between opposite wheel hubs. Exemplary embodiments accordingly likewise comprise an E-axle with all the components.

Exemplary embodiments relate also to a vehicle, in particular to a utility vehicle, with one of the drivetrains defined above.

At least part of the above-mentioned problems is solved in that both the electric drive and the vehicle brake couple to the high-speed side of the transmission, while the wheels couple to the opposite side of the transmission. Since the torque level acting on the brake and the drives is thereby reduced, the electric drives and the vehicle brakes can in this manner be made smaller and accordingly costs can be saved. As a result, all the components can be integrated in a compact manner into an E-axle (a drivetrain which is formed along an axle).

The exemplary embodiments of the present invention will be better understood from the following detailed description and the accompanying drawings of the different exemplary embodiments which, however, are not to be interpreted as limiting the disclosure to the specific embodiments but serve merely for explanation and understanding.

### BRIEF DESCRIPTION OF THE DRAWINGS

FIGS. 1A, 1B, 1C and 1D show exemplary embodiments of the present invention without a differential.

FIGS. 2A, 2B and 2C show exemplary embodiments of the present invention with a differential and at least two transmission units.

FIGS. 3A, 3B and 3C show exemplary embodiments of the present invention with a differential and a transmission.

### DETAILED DESCRIPTION

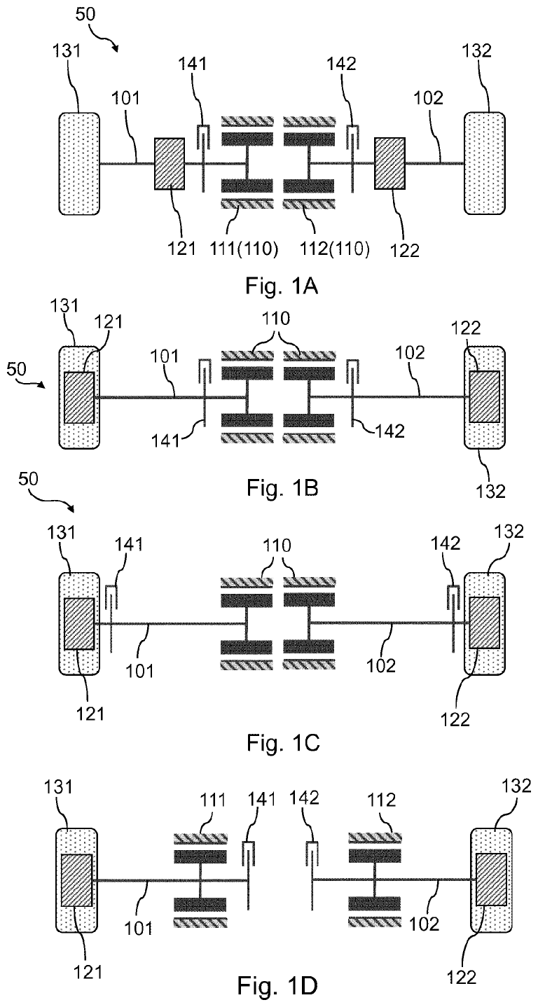

FIG. 1A-1D show exemplary embodiments of a brake device for a drivetrain 50 of utility vehicles, wherein two electric drives 111, 112 are present and therefore a differential is not required.

The locations mentioned in the following are to relate always to the flow of power along the drivetrain and not necessarily to the attachment in the vehicle.

FIG. 1A shows a drivetrain 50 with a first wheel hub 131, a first transmission 121, a first vehicle brake 141 and a first electric motor 111. These components constitute a first drivetrain along a first drive axle 101 for a first wheel (for example one of the rear wheels; not shown in FIG. 1A). The first wheel brake 141 is configured to brake the first wheel hub 131. In the exemplary embodiment shown, the first wheel brake 141 is arranged between the first transmission 121 and the first electric motor 111.

In the same manner, a second transmission 122, a second vehicle brake 142 and a second electric motor 112 couple to a second wheel hub 132 via a second drive axle 102, specifically in such a manner that the second vehicle brake 142 is arranged between the second electric motor 112 and the second transmission 122. The second vehicle brake 142 is configured to brake a wheel of the vehicle at the second wheel hub 132.

As already mentioned, this arrangement offers the advantage that the torque at the brake 141, 142 is smaller than in conventional brake devices (since the transmission converts the torques). Although higher speeds are present there, the vehicle brakes 141, 142 can nevertheless be made smaller, since the acting torque is smaller.

FIG. 1B shows a further exemplary embodiment in which the first transmission 141 is integrated in the first wheel hub 131, or arranged in the vicinity thereof. Likewise, the second transmission 122 is integrated into the second wheel hub 132. In the exemplary embodiment shown, the first vehicle brake 141 and the second vehicle brake 142 are still arranged spatially in the vicinity of the first electric motor 111 and of the second electric motor 112.

In the exemplary embodiment of FIG. 1C, the first vehicle brake 141 is additionally integrated at or in the first wheel hub 131. Likewise, the second vehicle brake 142 is integrated at or in the second wheel hub 132. A first axle 101 is still formed between the first electric motor 111 and the first wheel hub 131, so that the first electric motor 111 is not integrated at or in the wheel hub 131. The same applies for the second electric motor 112, which is spaced apart from the second wheel hub 132 likewise by a second axle 102 and is not integrated in or at the second wheel hub 132.

The vehicle brakes 141, 142 can be arranged along the drivetrain 50 upstream or downstream of the electric drive motors 111, 112. FIG. 1D shows an exemplary embodiment in which the vehicle brakes 141, 142 are arranged downstream of the drive motors 111, 112, so that the drive motors 111, 112 are each between the respective vehicle brake 141, 142 and the respective transmission 121, 122. For this purpose, the drive shafts 101, 102 can be guided through the electric drive motors 111, 112, for example.

Since two independent electric drive motors 111, 112 are present in this exemplary embodiment, the electric drive motors 111, 112 can also be integrated in or at the wheel hub 131, 132 according to further exemplary embodiments.

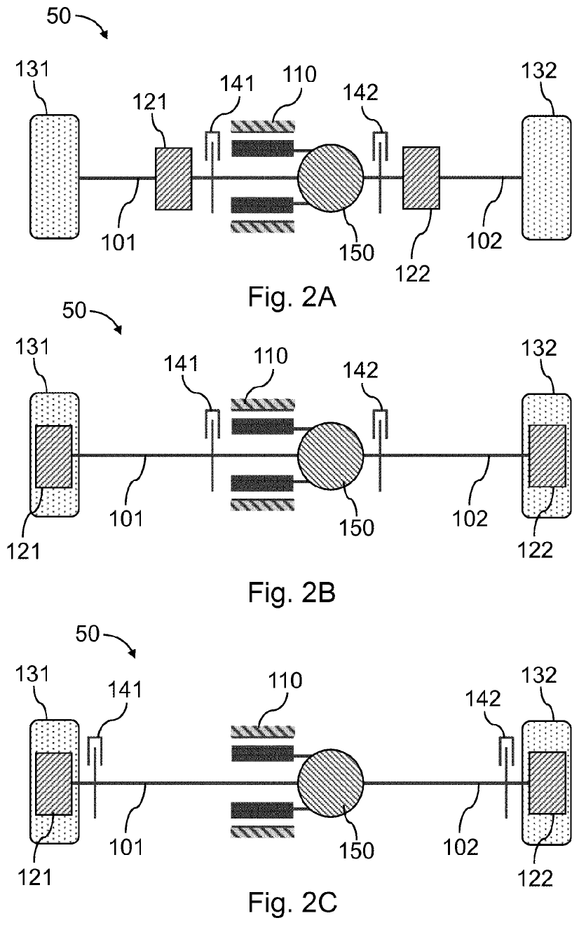

FIG. 2A-2C show further exemplary embodiments of the present invention with a differential 150 and at least two transmission units 121, 122. The differential 150 offers the advantage that only one electric drive motor 110 must be present. The additional differential 150 is formed between the first wheel hub 131 and the second wheel hub 132, wherein the electric motor 110 is arranged downstream of the differential 150 (as seen along the flow of power from the wheel hubs 131, 132).

The exemplary embodiments of FIG. 2A-2C comprise, as in FIG. 1A-1D, a first transmission 121 and a second transmission 122, which are formed between the respective wheel hub 131, 132 and the respective vehicle brake 141 and 142. The first vehicle brake 141 and the second vehicle brake 142 are arranged between the differential 150 and the respective transmission (the first transmission 121 and the second transmission 122).

In the exemplary embodiments shown, only one electric motor 110 is formed, wherein it is likewise possible that the vehicle brakes 141, 142 are formed along the drivetrain between the electric motor 110 and the differential 150.

The difference between the exemplary embodiments of FIG. 2A-2C again relates to the different possibilities for integration in the wheel hubs 131, 132. In FIG. 2A, none of the components is integrated in the respective wheel hub 131, 132. In the exemplary embodiment of FIG. 2B, the first transmission 141 and the second transmission 122 are integrated in the respective wheel hub 131, 132. In the exemplary embodiment of FIG. 2C, the first vehicle brake 141 and the second vehicle brake 142 are additionally integrated at or in the first or second wheel hub 131, 132, respectively.

The order of the individual components has remained the same, only the positions of the individual components have been placed closer to the wheel hubs 131, 132. In the exemplary embodiment of FIG. 2C, the differential 150, for example, remains arranged at a distance from the first wheel hub 131 and the second wheel hub 132, wherein the distance is bridged by the first and second drive shaft 101, 102.

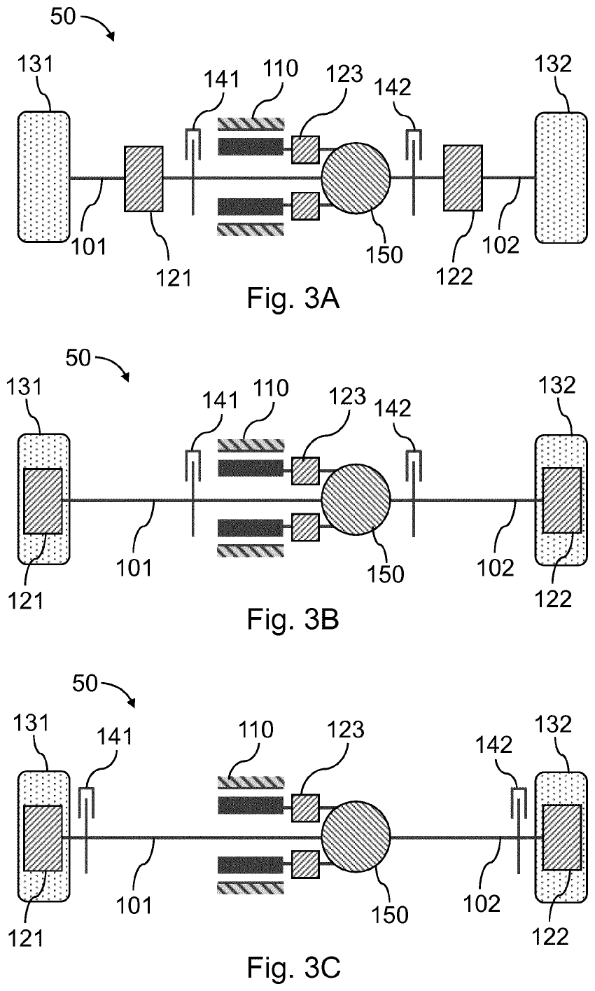

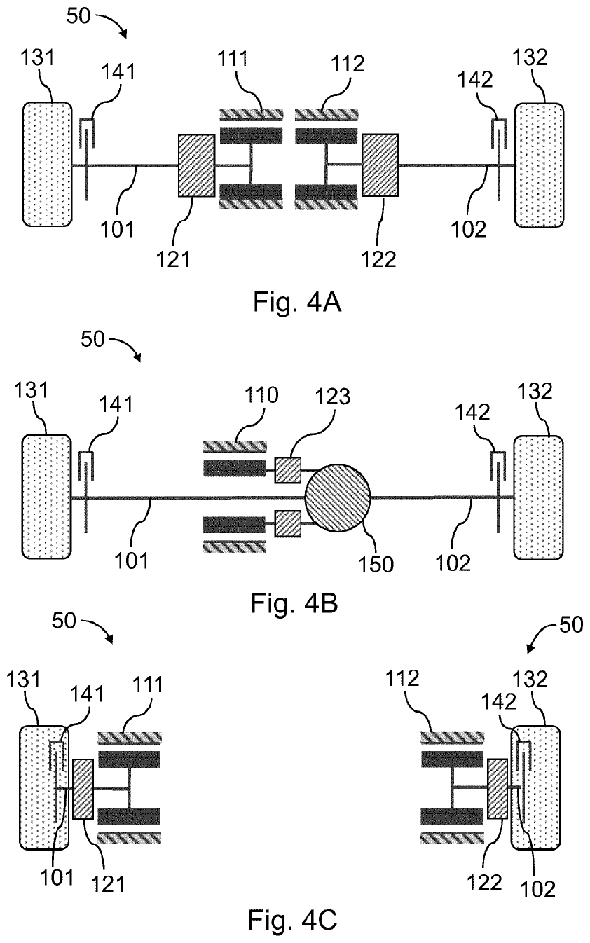

FIG. 3A-3C show exemplary embodiments of the present invention with a differential and an additional transmission. In contrast to the exemplary embodiments of FIG. 2A-2C, an additional further transmission 123 is here arranged between the differential 150 and the electric motor 110 in each case. The additional further transmission 123 can comprise a planetary transmission, for example.

All the further components are arranged in the same manner as shown in the exemplary embodiments of FIG. 2A-2C, so that it is not necessary to repeat the description.

In all the exemplary embodiments described, all the components can be formed along a single axle, which then constitutes a so-called E-axle. Therefore, according to further exemplary embodiments, the drivetrain 50 of the utility vehicle can constitute an E-axle, in which there are arranged along the vehicle axle—as seen from the outside in—first the wheel hubs 131, 132, then the transmission units 121, 122, followed by the vehicle brakes 141, 142 and the electric motors 111, 112, or there follows only one electric motor 110, which is separated from the vehicle brakes 141, 142 by a differential 150.

In further exemplary embodiments, at least one vehicle brake 141, 142 can be formed along the drivetrain downstream of the electric prime mover 110. For example, a drive shaft can extend through the electric motor 110, and the electric motor 110 can be arranged between the at least one vehicle brake 141, 142 and the wheel hub(s) 131, 132.

Exemplary embodiments relate also to vehicle brakes for electrically driven axles of utility vehicles, wherein according to the present invention the shaft which rotates at the higher speed owing to the transmission 131, 132 is used both for the drive and for the brake 141, 142. As a result, it becomes possible not only to use an electric drive motor 110, 111, 112 of small size, but also to make the vehicle brake(s) 141, 142 smaller, since the torques to be applied on braking are smaller than if the brake were to be installed directly on the wheel hub. An advantage of exemplary embodiments is that the same braking action can be achieved using the high-speed shaft—but with a significantly reduced braking torque within the braking mechanism. As a result, a more compact vehicle brake is made possible. In addition, the requirements in terms of the actuator performance are lower, which is advantageous in particular for brakes 141, 142 which are driven by an electric motor operation.

The specific form of the vehicle brakes 141, 142 can freely be chosen. Exemplary embodiments of the present invention are not to be limited only to electrically operated vehicle brakes 141, 142 (with electric actuators). It is likewise possible to use pneumatic vehicle brakes and hydraulic vehicle brakes. The vehicle brake 141, 142 can also comprise a parking brake function, wherein the braking force is applied, for example, by a spring.

Since, according to exemplary embodiments, the vehicle brake 141, 142 is arranged closer to the electric drives 110, 111, 112, liquid cooling can be provided for the vehicle brake and/or for the electric prime mover. Both can be cooled together.

The features of invention that are disclosed in the description, the claims and the figures can be fundamental to the implementation of the invention both individually and in any desired combination.

### LIST OF REFERENCE NUMERALS

50 drivetrain

101, 102 drive shafts

110, 111, 112 electric drives

121, 122 transmission

123 further transmission

131, 132 wheel hubs

141, 142 vehicle brakes

150 differential

1-13. (canceled)

14. A brake device for a utility vehicle with a drivetrain, comprising:
a vehicle brake, which is arranged along the drivetrain, as seen from at least one wheel hub, downstream of at least one transmission;
wherein the drivetrain includes the at least one electric drive motor, the at least one transmission and the at least one wheel hub.

15. The brake device of claim 14, wherein the vehicle brake is arranged along the drivetrain upstream or downstream of the at least one electric drive motor.

16. The brake device of claim 14, wherein the vehicle brake includes at least one of a pneumatic actuator, a hydraulic actuator, and/or an electric actuator.

17. The brake device of claim 14, wherein there is liquid cooling for the vehicle brake and/or at least one electric prime mover.

18. The brake device of claim 14, wherein the vehicle brake includes a parking brake function.

19. A drivetrain for a utility vehicle, comprising:
at least one electric drive motor;
at least one transmission;
at least one wheel hub, wherein the at least one transmission is arranged between the at least one electric drive motor and the at least one wheel hub; and
a brake device, including a vehicle brake, which is arranged along the drivetrain, as seen from the at least one wheel hub, downstream of the at least one transmission;
wherein the drivetrain includes the at least one electric drive motor, the at least one transmission and the at least one wheel hub.

20. The drivetrain of claim 19, wherein there is a differential between the at least one electric drive motor and the at least one wheel hub.

21. The drivetrain of claim 20, wherein a further transmission is provided between the differential and an electric drive motor.

22. The drivetrain of claim 19, wherein there are two electric drive motors, each of which couple to a wheel hub of a vehicle axle without a differential.

23. The drivetrain of claim 19, wherein the vehicle brake is arranged between the at least one electric drive motor and the at least one wheel hub.

24. The drivetrain of claim 19, wherein the at least one transmission is integrated in the at least one wheel hub.

25. The drivetrain of claim 19, wherein the at least one electric drive motor, and wherein the at least one transmission and the at least one vehicle brake are arranged along an axle between two opposite wheel hubs.

26. A vehicle, comprising:
a drivetrain for a utility vehicle, including:
at least one electric drive motor;
at least one transmission;
at least one wheel hub, wherein the at least one transmission is arranged between the at least one electric drive motor and the at least one wheel hub; and
a brake device, including a vehicle brake, which is arranged along the drivetrain, as seen from the at least one wheel hub, downstream of the at least one transmission;
wherein the drivetrain includes the at least one electric drive motor, the at least one transmission and the at least one wheel hub.

27. The vehicle of claim 26, wherein the vehicle is a utility vehicle.
